(19) United States
(12) Patent Application Publication
(10) Pub. No.: US 2015/0187518 A1
(43) Pub. Date: Jul. 2, 2015

(54) SECTIONALIZED CONTACT CONTACTOR

(71) Applicant: Gigavac, LLC, Carpinteria, CA (US)

(72) Inventor: Mike Molyneux, Santa Barbara, CA (US)

(73) Assignee: Gigavac, LLC, Carpinteria, CA (US)

(21) Appl. No.: 14/584,966

(22) Filed: Dec. 29, 2014

Related U.S. Application Data
(60) Provisional application No. 61/921,171, filed on Dec. 27, 2013.

(51) Int. Cl. H01H 1/06; H01H 9/04; H01H 1/58

(52) U.S. Cl. CPC H01H 1/06; H01H 1/58; H01H 9/041

(57) ABSTRACT

Described herein are contactors comprising one or more split or otherwise sectionalized contacts. By comprising split contacts, contactors incorporating features of the present invention increase the number of electrical contact sites between the split contactor and another contactor, allowing current to flow through multiple sites and preventing or mitigating the formation of magnetic fields, harmonic resonance and resulting vibration and noise production. In some embodiments, the contactors comprise at least one bifurcated (split in two) moveable contact and at least one fixed contact. The bifurcated contact can be configured such that it can be easily manipulated as if it were a singular contact, while simultaneously providing the advantages of a bifurcated one.

### CROSS REFERENCE TO RELATED APPLICATIONS

This application claims the benefit of U.S. Provisional Patent Application Ser. No. 61/921,171, filed on 27 Dec. 2013, to Mike Molyneux, entitled SPLIT CONTACT CONTACTOR, which is hereby incorporated herein in its entirety by reference.

### BACKGROUND OF THE INVENTION

1. Field of the Invention

The present invention relates to contactors, and particularly to sealed contactors comprising moveable contacts.

2. Description of the Related Art

Hermetically sealed contactors are used for repeatedly establishing and interrupting an electrical power circuit and for switching of high electrical currents and/or high voltages and are commonly utilized in industries where such switching is desirable, for example, the automotive industry. These contactors typically have fixed and movable internal contacts, and an internal actuating mechanism supported within a hermetically sealed housing. In one type of contactor, air is removed from the contactor housing to create a vacuum that suppresses arc formation, provides long operating life and allows for low resistance operation of the contactor. In another type of contactor, the evacuated chamber can be backfilled under pressure with an insulating gas, which allows the contactor to operate with good arc-suppressing properties.

One type of conventional contactor has moving components housed within a ceramic housing. These types of contactors can operate with a vacuum formed in the housing or with the housing having internal pressure from an injected gas. This allows the contactors to operate with higher voltage and/or lower resistance characteristics. Ceramic housings also allow the contactors to operate at high temperatures. Ceramic housings, however, can be expensive and difficult to manufacture. Contactors may also comprise a housing with a ceramic header. Ceramic headers offer many of the same voltage, resistance and/or temperature characteristics of ceramic housings as well as offering a means whereby contacts can be electrically isolated from one another. Traditional ceramic headers can be difficult and expensive to manufacture because they are complex shapes that require special tooling, difficult metallization, and time consuming post processes.

Current hermetically sealed contactors also have housings that are complex shapes of ceramic or are epoxy sealed plastic. Epoxy sealed housings can be more prone to failure at high temperature and the all-ceramic envelope products can be very expensive. While the use of flat ceramic can be used, one problem is that the arc chamber is separate from the header. During high current interrupt, arc plasma could reach other metal parts outside the arc chamber if it is not properly sealed. To properly seal the chamber, epoxy or a brazement could be used, however they must be exact solutions dimensionally and can reduce the performance and/or increase the price.

Additionally, conventional contactors can have a movable plunger component that can be driven by a solenoid in order to move the movable contacts to the stationary contact. Sealed solenoid driven contactors can be problematic due to pressure build-up on one side of the plunger during plunger travel. This imbalance of pressure slows plunger movement and can reduce solenoid performance. To address this, some relays are provided with a bigger gap in the plunger to reduce the magnetic force or they will machine in expensive grooves to allow gas to flow by the outside of the plunger as the plunger moves to the stationary contacts.

Additional examples of hermetically sealed contactors can be found in U.S. Pat. No. 8,446,240 to Swartzentruber, et al., filed on Apr. 20, 2011, which is hereby incorporated herein in its entirety by reference, including the drawings, charts, schematics, diagrams and related written description. The contactors illustrated therein demonstrate embodiments setting forth efficient contactors that can be utilized for the purposes described above.

Even with such efficient contactors, in some applications, for example, in the automobile industry or other application utilizing high currents (in excess of ˜1,000 amps), the flow of electricity through the contact portions of the contactor can generate opposing magnetic fields, resulting in the formation of harmonic resonance. This resonance can manifest in a variety of undesirable ways, for example, as a vibration in the contactor or as an unpleasant noise, such as a “droning” or “humming” noise.

An improved contactor comprising features to reduce the manifestation of harmonic resonance and to otherwise compensate for the resulting production of unwanted vibrations and noise is therefore needed.

### SUMMARY OF THE INVENTION

Described herein are contactors comprising features to reduce the incidence of harmonic resonance and thus to prevent and/or mitigate the resulting vibrations and noise. Contactors incorporating features of the present invention can include one or more contacts that are shaped, split or otherwise sectionalized into two or more sections. This allows for the contact to establish additional contact points with other contacts, which can reduce the formation of magnetic fields, as will be discussed in further detail below. In some embodiments, a moveable contact comprises a bifurcated contact held together, such that it can function as a single moveable contact while providing additional contact points.

In one embodiment, a contactor comprises a housing, which comprises internal components for changing the state of the contactor between connect and disconnect states, with the internal components comprising at least two contacts with at least one shaped to increase the number of contact sites between the contacts when the contactor is in a connect state. The contactor further comprises a mechanism for controlling the internal components as needed to change the state of the contactor between connect and disconnect states.

In another embodiment, a contactor comprises a housing comprising internal components for changing the state of the contactor between connect and disconnect states, with the internal components comprising at least one moveable contact and at least one fixed contact. At least one of the at least one moveable contact or the at least one fixed contact is divided into two or more sections. The contactor further comprises one or more connecting structures configured to electrically connect the internal components to external circuitry, as well as a mechanism for controlling the internal components as needed to change the state of said contactor between connect and disconnect states.

In yet another embodiment, a contactor comprises a housing, at least one moveable contact within the housing, the moveable contact divided into two or more sections, at least one fixed contact within said housing, the fixed contact is configured to electrically connect to external circuitry, and a mechanism for controlling the at least one moveable contact.

In still another embodiment, a contactor comprises a housing, at least one moveable contact within the housing, the moveable contact comprising a patterned surface, at least one fixed contact within said housing, the fixed contact electrically connected to one or more connecting structures for connection to external circuitry, and a mechanism for controlling the moveable contact, such that the moveable contact can contact or break contact from the fixed contact, wherein the moveable contact's patterned surface is configured to increase the number of contact sites between the moveable contact and the fixed contact when the moveable and fixed contacts are contacting one another.

These and other further features and advantages of the invention would be apparent to those skilled in the art from the following detailed description, taking together with the accompanying drawings, in which:

### BRIEF DESCRIPTION OF THE DRAWINGS

FIG. 1 is perspective view of a contactor incorporating features of the present invention;

FIG. 2 is a sectional view of the contactor of FIG. 1;

FIG. 3 is an exploded view of the contactor of FIGS. 1 and 2 above;

FIG. 4 is an exploded view of a moveable contact configuration incorporating features of the present invention; and

FIG. 5 is a perspective view of the moveable contact configuration of FIG. 4.

### DETAILED DESCRIPTION OF THE INVENTION

Described herein are contactors comprising at least one contact that has been shaped to increase the contact sites and/or electrical pathways formed by the contact and another contact, for example, by dividing, splitting, patterning or otherwise sectionalizing the contacts. Such contacts can be sectionalized by physically cutting and separating the contact into two or more parts, for example, by dividing the contact in half. In embodiments wherein a contact is physically separated into two or more pieces, additional structures can be utilized such that the sectionalized contact can be moved and operated as if it were a singular body, while simultaneously providing the advantages of the divided body; in some embodiments, clip and carrier structures are utilized to accomplish this.

The contacts can also be sectionalized by altering portions of the contact, for example, altering the surface of the contact via mechanical, laser or chemical etching. This can alter the shape of the contact, for example, allowing the contact to comprise multiple sections divided by physical structures such as peaks and valleys, allowing the contact to interact with another structure, for example, another contact or site needing electrical communication such that the contact comprises additional contact points with the other structure. In some embodiments, the contact can be chemically treated, doped or have additional materials integrated into the contact's primary material. For example, in some embodiments, a dielectric material can be integrated within the contact to divide multiple sections of the contact's otherwise conductive structure, creating an effectively split contact.

A major reason for the dividing of the contact into multiple sections is due to the creation of magnetic fields during normal operation of the contactor, resulting in harmonic resonance. The harmonic resonance can result in unwanted vibrations of internal components of the contactor as well as the production of unpleasant humming or droning noises. In typical contactors, one or more moveable contacts are configured in relation to other fixed contacts such that the contactor has at least two states: one wherein the one of more moveable contacts are not contacting the fixed contacts (an “off” or “disconnect” state) and a second wherein the one of more moveable contacts are contacting the fixed contacts (an “on” or “connect” state).

At higher currents, for example, ˜1,000 amps or greater, while a moveable contact is connected to a fixed contact and the contactor is in the “connect” state, a magnetic field can be formed. Such a field forms easily when there is a small number of contact points between the moveable and fixed contacts, such as in the situation where there is one of each contact type, as the high current flows through a small number of contact points.

By dividing the contact into two or more sections and/or pieces, magnetic field generation is mitigated. This is due to the number of contact points between the moveable and fixed contacts increasing due to the sectionalizing of the contact, resulting in less current passing through the same point. Additionally, harmonic resonance is mitigated as additional flow paths for the electrical flow between the two types of contacts are established. In some embodiments, multiple moveable contacts can be simultaneously utilized with a single fixed contact (or vice versa) to increase the amount of contact points and flow pathways between the two types of contacts.

Throughout this description, the preferred embodiment and examples illustrated should be considered as exemplars, rather than as limitations on the present invention. As used herein, the term “invention,” “device,” “method,” “present invention,” “present device” or “present method” refers to any one of the embodiments of the invention described herein, and any equivalents. Furthermore, reference to various feature(s) of the “invention,” “device,” “method,” “present invention,” “present device” or “present method” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing.

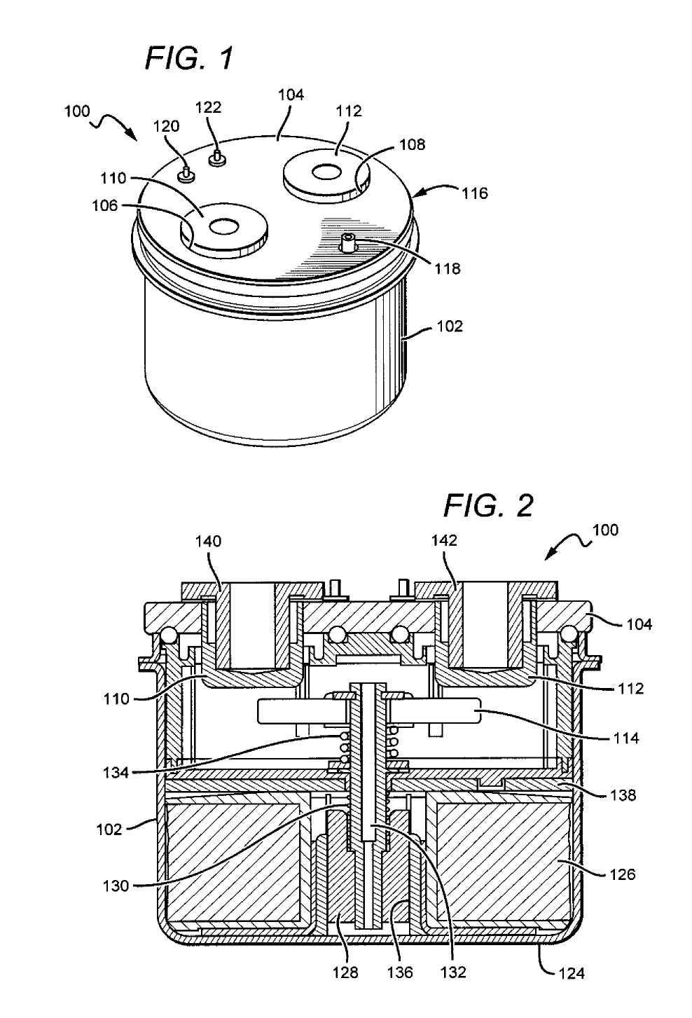

Before explaining split contact contactor configurations incorporating features of the present invention in greater detail, it is useful to set forth some example environments wherein split contacts according to the present disclosure can be utilized. Such example environments are set forth below and additional example environments can be found in U.S. Pat. No. 8,446,240 to Swartzentruber, et al., filed on Apr. 20, 2011, which has been expressly incorporated by reference above. FIG. 1 shows a contactor 100, comprising a housing 102 and a header 104, which can be substantially flat to help make tooling inexpensive, the metallization simple, and the post processes less complicated.

The header 104 is preferably made of ceramic, although other materials resistant to high temperatures may be used. Header 104 comprises first and second contact holes 106, 108 sized so that fixed contacts 110 and 112 can pass through the header 104 to make electrical contact with moveable contact 114 (inside housing 102; shown in FIG. 2). The contact holes 106, 108 and the outer rim of the header 104 can be coated with an electrically conductive material, with a preferred conductive material comprising a metal, such as copper.

The header 104 can be formed into a braze assembly 116, with a sealed evacuation tube 118 and sets of vertical members 120, 122. The evacuation tube 118 is arranged to allow gasses to be injected into the housing, preferably under pressure. In other embodiments, the tube 118 can be used to create a vacuum in the housing 102. After the gasses are injected (or vacuum created) the tube is sealed so that no further gasses can pass in or out. The sets of vertical members 120, 122 pass through the header 104, with some members 120 arranged to contact auxiliary contacts, and other members 122 arranged to contact a printed circuit board (PCB).

FIG. 2 shows a sectional view of the contactor 100 of FIG. 1 comprising a housing 102 having an outer cup 124 and a substantially flat header 104. The contactor's internal moving components can be arranged on the header 104 as further described below and the header 104 is sized and arranged to mate with and mount in the opening of the cup 124, such that there is a hermetic seal between the two. The contactor's 100 internal moving components are held in the sealed internal chamber defined by the header 104 and the cup 124. The contactor's internal components are also contacted through the header 104. Operation of contactors is generally known in the art and is only briefly discussed with reference to the different components in contactor 100.

The contactor's internal components, include a mechanism for changing the state of the contactor, with one mechanism being a solenoid 126. Many different solenoids can be used, with a suitable solenoid operating under a low voltage and with a relatively high force. One example of a suitable solenoid is commercially available solenoid Model No. SD1564 N1200, from Bicron Inc., although many other solenoids can be used. The internal components can further comprise a plunger 128, a plunger spring 130, a hollow plunger shaft 132, a contact spring 134, a solenoid opening 136, a circular plate 138, and a moveable contact 114. Most of the plunger 128 is arranged within solenoid 126 with a small portion protruding from the solenoid opening 136. The hollow plunger shaft 132 goes through the middle of the plunger 128 with the plunger spring 130 held between the lower portion of the plunger 128 and substantially circular plate 138. When the solenoid 126 is energized, the plunger 128 is drawn fully from the solenoid and the plunger spring 130 is compressed between the lower portion of the plunger 128 and the circular plate 138. When the solenoid 126 is not energized, the plunger 128 is urged by the plunger spring 130 to extend at least partially in the solenoid 126. The hollow plunger shaft 132 enables the plunger 128 to move readily in a sealed environment, as the hollow plunger shaft 132 allows any gas within the sealed housing 102 to flow freely through the plunger 128 and the pressure to equalize during the travel of plunger 128.

When the solenoid 126 is energized, it moves the moveable contact 114 a certain distance known as the contact gap before it makes contact with fixed contacts 110, 112. The contact gap provides the electrical isolation to stop current flow when the movable contact 114 is not in contact with the fixed contacts 110, 112. After moveable contact 114 makes contact with fixed contacts 110, 112, the plunger 128 continues to move and compresses the contact spring 134. This additional post-contact movement of the plunger is known in the art as plunger overtravel.

It is understood that while a solenoid is shown and disclosed as one embodiment, other mechanisms of moving the moveable contact 114 can be utilized including various types of actuators and manually operable mechanisms. Some example manually operable mechanisms are set forth in U.S. patent application Ser. No. 13/654,882 to Mike Molyneux, et al., entitled HERMETICALLY SEALED MANUAL DISCONNECT, published as US 2013/0102175 A1, which is hereby incorporated herein in its entirety by reference, including the drawings, charts, schematics, diagrams and related written description.

The fixed contacts 110, 112 and/or the moveable contact 114 can be electrically connected to external circuitry such that the contactor 100 can interrupt such a connection when the fixed contacts 110, 112 and the moveable contact 114 are not contacting each other (putting the contactor 100 and a connected electrical device in an “off” or “disconnect” state) or can complete the circuit and allow electrical flow through the contactor when the fixed contacts 110, 112 and the moveable contact 114 are contacting each other (putting the contactor 100 and a connected electrical device in an “on” or “connect” state). Many different electrical connection structures for providing an external electrical connection that are known in the art can be used.

FIG. 2 shows an example connection structure wherein first and second electrical terminal studs 140, 142 are utilized such that they are connected to the fixed contacts 110, 112. When the movable contact 114 is contacting the fixed contacts 110, 112, an electrically conductive path is formed between first and second terminal studs 140, 142, which are typically connected to the fixed contacts 110, 112. The terminal studs 140, 142 can be located externally to the housing 102 in different embodiments, but it is understood that the terminal studs 140, 142 can be arranged in a number of different ways. The terminal studs 140, 142, or another electrical connection structure can be connected to external electrical circuitry, such that the state of the contactor (i.e. “connect” or “disconnect”) dictates the state of a connected electrical circuit or device (i.e. “On” or “off” respectively). In other embodiments, the fixed contacts 110, 112 can at least partially protrude externally from the housing and can be directly connected to external circuitry or another external connection structure.

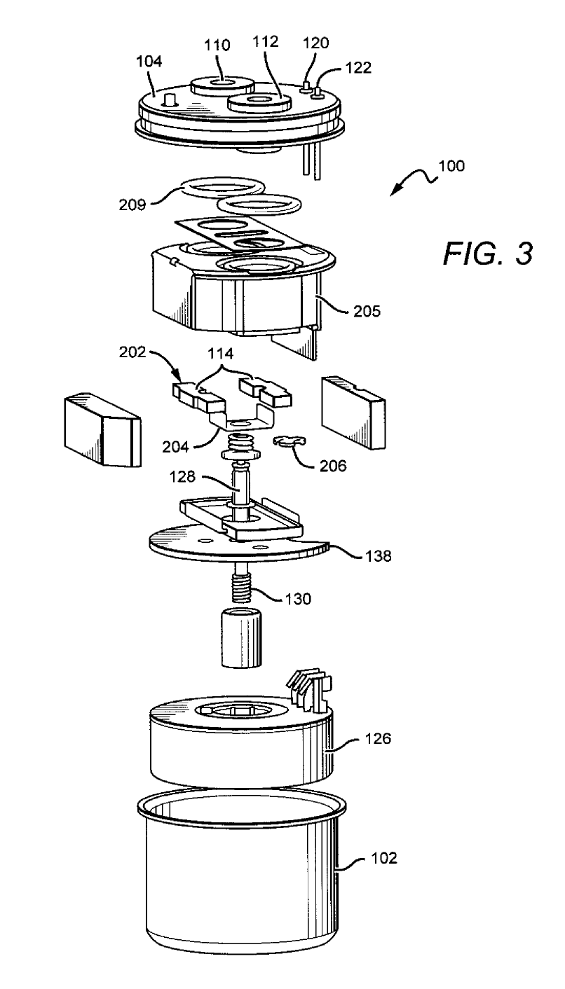

Now discussing more specifically the split contactor configuration, FIG. 3 shows an exploded view of contactor 100, which more clearly shows moveable contact 114 comprising a split contactor configuration 202, which would allow for the moveable contact 114 to form additional contact sites when the moveable contact 114 contacts the fixed contacts 110, 112. Also shown in FIG. 3 is the housing 102, the header 104, the solenoid 126, the plunger 128, the plunger spring 130 and the circular plate 138. In the embodiment shown, the moveable contact 114 is bifurcated (split into two portions) and held in place by a carrier structure 204. A clip mechanism 206 can be further provided to secure the bifurcated contact in place (shown better in FIG. 5 below). The moveable contact 114 can be divided into two or more sections by various means known in the art, for example by machining or various types of etching.

The carrier structure 204 can comprise any material known in the art that is sturdy can reliably hold the moveable contact 114 in place. Some materials the carrier structure 204 can comprise include, but are not limited to, metals, polymers and various plastics, such as commercially available polyvinyheaderene chloride (PVDC), nylon and polyethylene terephthalete (PET), or ethylene vinyl alcohol (EVOH). The clip mechanism 206 can comprise similar materials. Both the carrier structure 204 and the clip mechanism 206 can comprise a variety of shapes including any regular or irregular polygon as well as any shape that can interact with the moveable contact 114 and/or other components within the contactor 100 to stabilize or secure multiple portions of moveable contact 114 in a desired position.

FIG. 3 further shows an electronic compartment 205, which can house further electronic control components such a PCB and/or can provide connection to external electrical circuitry, for example, through vertical members 120, 122 or through connected terminals of wiring. The contactor 100 can further comprise other structures such as o-rings 209, which can provide a more substantial seal, for example, in embodiments wherein the contactor is hermetical or hydrostatically sealed.

While the embodiment shown in FIG. 3 depicts a bifurcated moveable contact 114, it is understood that the moveable contact 114 can be split into more than two sections to further increase the number of contact points between the moveable contact 114 and the fixed contacts 110, 112. Furthermore, it is understood that while the moveable contact 114 is shown as being split and the fixed contacts 110, 112 are shown as being singular, various other arrangements could exist. For example, the fixed contacts 110, 112 can be split while the moveable contact 114 can be singular or both the moveable contact 114 and the fixed contacts 110, 112 can be split. It is further understood, that the plunger 128 can comprise portions holding multiple moveable contacts to contact the same fixed contact, increasing the contact points as discussed above.

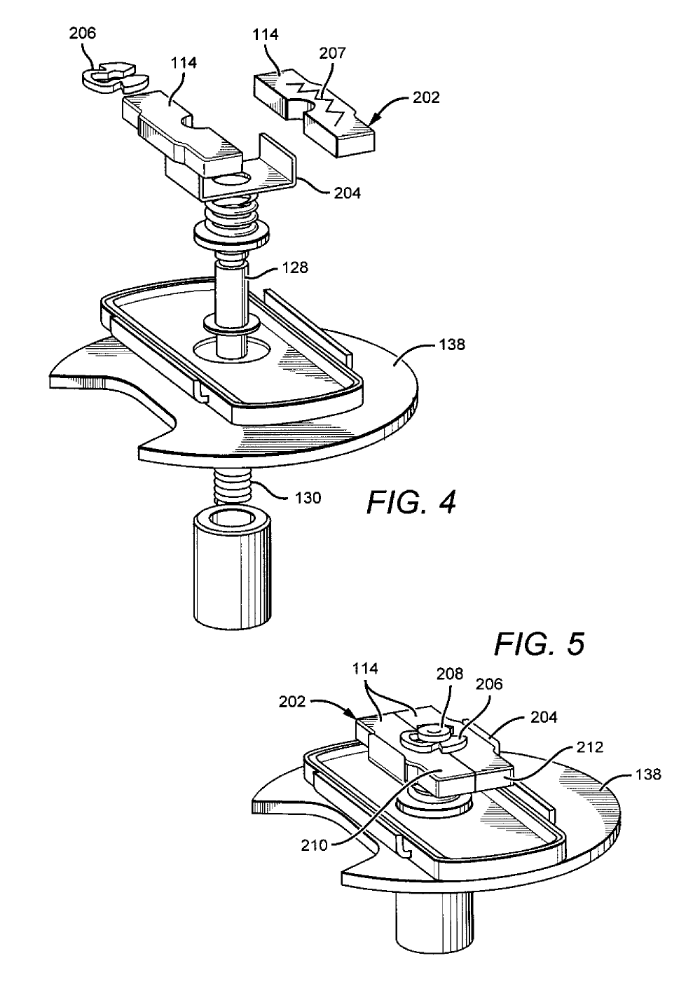

FIG. 4 shows a more detailed view of the split contactor configuration 202 portion of FIG. 3 above, showing moveable contact 114, which has been bifurcated, and which can be held in place by the carrier structure 204 and clip mechanism 206. FIG. 4 also shows the plunger 128, the plunger spring 130 and the circular plate 138.

As discussed above, in addition to or in lieu of dividing a contact to provide additional contact sites, the contact can simply be shaped or roughened to create additional contact sites. An example of this is shown in FIG. 4, which demonstrates patterned surface 207 of a portion of moveable contact 114. This allows for additional contact sites and electrical pathways to be formed between the patterned surface 207 of the moveable contact 114 and the fixed contacts. While FIG. 4 shows that the moveable contact 114 can comprise the patterned surface 207, it is understood that the fixed contacts can also be patterned or shaped in such a manner.

FIG. 5 shows an assembled view of the split contactor configuration 202 in FIG. 4 above. As shown, the moveable contact is bifurcated, but held in place by the carrier structure 204 and held together by clip mechanism 206. The split contactor configuration 202 can further comprise one or more additional securing elements 208 (one shown) to further secure individual portions of moveable contact 114 together. In the embodiment shown, additional securing element 208 functions as a washer-like structure helping clip mechanism 206 to secure moveable contact 114 to carrier structure 204.

By positioning the bifurcated moveable contact 114 such that both the first half 210 and the second half 212 are adjacent, the moveable contact 114 can operate as a single contact as discussed above, for example, being moved by the motion of the plunger as a single unit, while at the same time providing the benefits of multiple contacts, including the increase in the number of contact points and the shunt in current to another portion as discussed above.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above.

The foregoing is intended to cover all modifications and alternative constructions falling within the spirit and scope of the invention as expressed in the present disclosure, wherein no portion of the disclosure is intended, expressly or implicitly, to be dedicated to the public domain if not set forth in the claims.

I claim:

1. A contactor, comprising:
a housing comprising internal components for changing the state of said contactor between connect and disconnect states, said internal components comprising at least two contacts, wherein at least one of said at least two contacts is shaped to increase the number of contact sites between said at least two contacts when said contactor is in said connect state; and
a mechanism for controlling said internal components as needed to change the state of said contactor between said connect and disconnect states.

2. The contactor of claim 1, wherein said housing is hermetically sealed.

3. The contactor of claim 2, further comprising an evacuation tube.

4. The contactor of claim 1, wherein said at least one contact shaped to increase the number of contact sites is divided into two or more sections.

5. The contactor of claim 4, wherein said at least one contact shaped to increase the number of contact sites is bifurcated.

6. The contactor of claim 4, further comprising a carrier structure configured to hold said two or more sections.

7. The contactor of claim 6, further comprising a clip mechanism for securing said two or more sections together.

8. The contactor of claim 1, wherein said at least one contact shaped to increase the number of contact sites comprises a patterned surface.

9. A contactor, comprising:
a housing comprising internal components for changing the state of said contactor between connect and disconnect states, said internal components comprising at least one moveable contact and at least one fixed contact, wherein at least one of said at least one moveable contact or at least one fixed contact is divided into two or more sections;
one or more connecting structures configured to electrically connect said internal components to external circuitry; and
a mechanism for controlling said internal components as needed to change the state of said contactor between said connect and disconnect states.

10. The contactor of claim 9, wherein said housing is hermetically sealed.

11. The contactor of claim 10, further comprising an evacuation tube.

12. The contactor of claim 9, wherein said contact divided into two or more sections is bifurcated.

13. The contactor of claim 9, further comprising a carrier structure configured to hold said two or more sections.

14. The contactor of claim 13, further comprising a clip mechanism for securing said two or more sections together.

15. The contactor of claim 9, wherein said contact divided into two or more sections comprises a patterned surface.

16. The contactor of claim 9, wherein said one or more connecting structures comprise vertical members.

17. The contactor of claim 9, wherein said one or more connecting structures comprise terminal studs.

18. A contactor, comprising:
a housing;
at least one moveable contact within said housing, said at least one moveable contact divided into two or more sections;
at least one fixed contact within said housing, said at least one fixed contact configured to electrically connect to external circuitry;
a mechanism for controlling said at least one moveable contact.

19. The contactor of claim 18, wherein said housing is hermetically sealed.

20. The contactor of claim 19, further comprising an evacuation tube.

21. The contactor of claim 18, wherein said moveable contact is bifurcated.

22. The contactor of claim 18, further comprising a carrier structure configured to hold said two or more sections.

23. The contactor of claim 22, further comprising a clip mechanism for securing said two or more sections together.

24. The contactor of claim 18, wherein said moveable contact comprises a patterned surface.

25. A contactor, comprising:
a housing;
at least one moveable contact within said housing, said at least one moveable contact comprising a patterned surface;
at least one fixed contact within said housing, said at least one fixed contact electrically connected to one or more connecting structures for connection to external circuitry;
a mechanism for controlling said at least one moveable contact such that said at least one moveable contact can contact or break contact from said at least one fixed contact, wherein said patterned surface is configured to increase the number of contact sites between said at least one moveable contact and at least one fixed contact when said at least one moveable contact is contacting said at least one fixed contact.

26. The contactor of claim 25, wherein said housing is hermetically sealed.

27. The contactor of claim 26, further comprising an evacuation tube.

28. The contactor of claim 25, wherein said one or more connecting structures comprise vertical members.

29. The contactor of claim 25, wherein said one or more connecting structures comprise terminal studs.
